(19) United States
(12) Patent Application Publication
(10) Pub. No.: US 2018/0015903 A1
(43) Pub. Date: Jan. 18, 2018

(54) HEAD AND NECK SUSPENSION AND SUPPORT DEVICE

(71) Applicant: Daniel DEL RIO FRESEN, Las Palmas de Gran Canaria Islas Canaira (ES)

(72) Inventors: Daniel DEL RIO FRESEN, Las Palmas de Gran Canaria Islas Canaira (ES); Eva RAMON HERNANDEZ, Las Palmas de Gran Canaria Islas Canaira (ES)

(21) Appl. No.: 15/548,461

(22) PCT Filed: Jun. 28, 2016
(86) PCT No.: PCT/ES2016/070482

§ 371 Date: Aug. 3, 2017

(30) Foreign Application Priority Data
Jul. 7, 2015 (ES) U201530797

(51) Int. Cl. B60R 22/00; B60N 2/48; B60R 22/32

(52) U.S. Cl. CPC B60R 22/001; B60R 22/32; B60N 2/4805; B60N 2/4879

(57) ABSTRACT

The hereby invention consists in a head support system specially designed to be used by the user to rest while seated. It is made up of a set of bands that are joined together to create a single piece, which consists in the main circular band, dos lateral bands for frontal support, a posterior securing band, two inside stabilization bands and a cushion that may in included in the cushion-bag located to the lower and central area of the device.

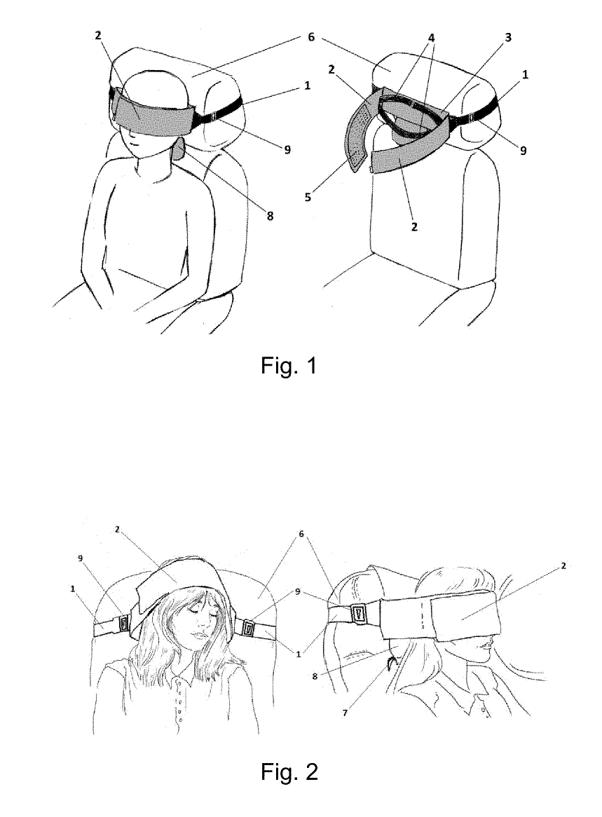

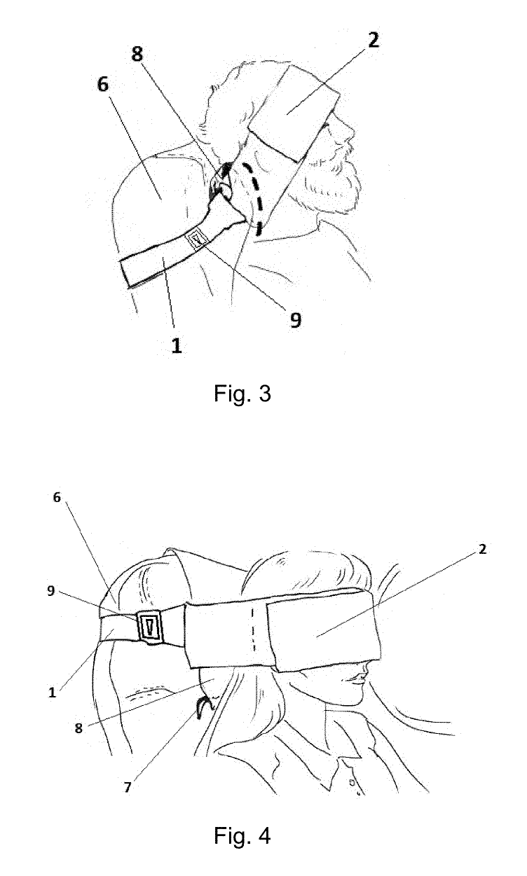

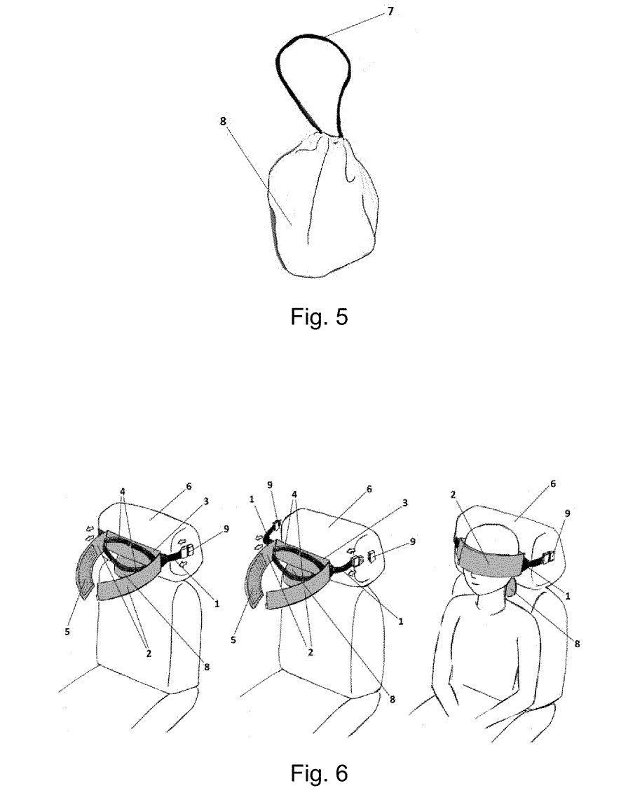

### AIM OF THE INVENTION

The hereby invention consists in a head supporting system, specially designed to be able to rest while seated. The revolutionary design is a clear and evident improvement to the current techniques used.

### FIELD OF THE INVENTION

This invention can be included within the field of rest while sitting upright, and therefore may have different uses.

Therapeutic field: a patient may need to remain seated due to medical condition because of certain pathologies that may require keeping an upright position.

Passenger transport field: The device provides passengers with optimal rest while travelling.

Automation field as a passive safety device: In addition to avoiding the well-known “neck lash” in moderate crashes, the system has the ability to break at one of its elements so that the user does not remain trapped.

### BACKGROUND OF THE INVENTION

So far, head and neck securing systems are manufactured to be used while sitting, either using simple bands, with a deficient design from an ergonomic point of view, or with the use of individual bands diversely configured. Among these, the most common is a circular band that is placed over the user's head as a band or a crown, and the remaining bands are then connected and fixed to the seat by means of different techniques. The result is rather complex and may have stability problems and risks because of its use over time as they do not take into consideration biomechanics and comfort.

### DESCRIPTION OF THE INVENTION

This invention consists in a set of bands, joined in such a way that it creates a unique piece, which may be fixed to a seat and the accommodation of the user's head within it, allowing the user to rest while seated.

This device is compatible with any kind of seat. It is preferably manufactured with textile or elastic materials that provide a secure hold while seated as well as optimal comfort for the user.

To achieve this, the device has a main band, closed at its endings, which is placed by sliding it onto the top of the seat. It is secured with a belt for a manual adjustment with a sliding adjustment system provided for this objective. This adjusting device can also be permanently installed onto the seat itself (image 6).

The relevant lateral bands are joined to this main band. They border the lateral-frontal region of the skull perimeter, and are joined to the main band.

Two additional internal bands are responsible for bordering the lateral-posterior region of the skull perimeter in order to soften lateral movements. Another band is responsible for holding and cushioning the occipital or posterior-inferior area of the head. The mixed actions of both contribute to the correct comfortable holding of the user's head.

At the lower end of the main band and located in the centre, there is a bag where the compacted device can be stored. It can also be filled to be used as a cushion, which can be included independently or within the system.

The user can use the systems directly, as appreciated in image 3. All that needs to be done is to place the main round band (1) over the back of the seat, and place the frontal securing lateral bands (2) over the head until the head is in the required position, fixing them together with a Velcro-type system. (5)

The permanent model would not have the main round circular band. Instead, the device may be fixed to a specifically designed headrest with temporary clips. Image 6

The cushion can be created from the self-keeping bag or can be previously installed in order for the user to achieve the highest level of comfort possible by positioning the cushion in the space between the back of the neck and the seat, also known as the physiological lordosis. Thus, the space is filled and the back of the neck can rest upon it.

The collocation of the frontal securing lateral bands (2) can be used for just holding the head, placing the bands over the user's forehead, as shown in image 3. It can also ease its rest, by placing them over the eyes, as appreciated in image 4.

In order to better understand the reach of this invention, the following images have been designed to describe it, with a preferred design given as an example and without being limited thereto.
Image 1 describes the procedure of how the user can use this invention.
Image 2 shows the two different ways of placing the band, securing the user's forehead and the region of the eyes.
Image 3 shows a way of placing the band, securing the user's forehead and using the cushion-bag for cervical support.
Image 4 shows another way of placing the band, covering the user's eyes and using the cushion-bag for cervical support.
Image 5 depicts the invention when stored within the cushion-bag.
Image 6 shows the permanent version on the seat.

As appreciated in the images, the main circular band is represented by (1), the frontal securing lateral bands by (2), the posterior securing band (3), the inside stabling bands (4), the Velcro-type securing system (5), the seat's back or head rest (6), the cushion-bag closing system (7), the cushion-bag (8), the adjustment and breakage clip (9).

### PREFERRED MANUFACTURING OF THE INVENTION

As appreciated in images 1 and 2, this invention consists in a main circular band (1) manufactured in an elasticised textile material. Its hollowness allows it to secured to a seat's back or headrest (6) which is has been created for. In order to secure its collocation and compatibility with any kind of seat, the main circular band (1) has a device within its main body that regulates its length and tension.

Two frontal securing lateral bands (2) are joined uniquely to the main circular band (1) creating an integral unit. One of these lateral bands has a Velcro-type securing system (5) incorporated to the internal side of the free end, which allows it to be connected to the other lateral band when they come into contact. This stabilizes the whole lateral-anterior area of the user's head.

Between the main circular band (1) and the frontal securing lateral bands (2), there is a posterior securing band (3) which is joined to the two former bands. This band is responsible for joining all the pieces together as well as becoming the support for the rest of the structure.

On the other hand, the frontal securing lateral bands (2) and the posterior securing band (3) are joined together with the stabilizing bands (4). They are responsible for supporting the lower part of the back of the neck and the lateral cushioning of the head.

Finally, the suspensory device with head and neck support can be stored within the cushion-bag (8), which is joined to the posterior securing band (3).

With regard to the permanent fixture to the seat itself (image 6), the main circular band (1) is replaced with a permanent fixing device to the seat which can be easily placed and removed (image 6).

It is interesting to note that this invention is made with materials that are suitable to be used in contact with human skin and/or the respiratory tract in order to avoid allergic and/or physiological reactions. In addition, it also has a linking system among its pieces which means that is can be broken in the event of an emergency and for safety reasons.

There may be variations to the basis of this invention, which are also protected. These variation include different manufacturing materials, the location and typology of the supporting device of the main circular band, the location of the posterior securing bands, and the securing system to join the lateral bands.

1- Suspensory and head and neck support device, which has a set of intertwined bands creating one piece. It has a

[symbol]

2. Suspensory and head and neck support device, according to claim 1, which is characterised because the main circular band (1) adjusts to the perimeter by sliding.

3. Suspensory and head and neck support device, according to claim 1, and that is characterised because the two frontal securing lateral bands (2), one on each side are joined together to the main circular band (1) allowing the support of the frontal area of the head with a Velcro-type system (5).

4. Suspensory and head and neck support device, according to claim 1, which is characterised by means of its posterior securing band (3), joined to the main circular band (1), where the back of the head can rest and it is where the cushion-bag is located (8).

5. Suspensory and head and neck support device, according to claim 1, which is characterized by having two internal stabilization bands (4) located inside the frontal securing lateral bands (2) which are thinner, with one of the bands joined to the posterior securing band (3) half way while the other one is not.

6. Suspensory and head and neck support device, according to claim 1 and which is characterised by having a cushion-bag (8) to store the device, located at the lower centred part and joined only to the posterior securing band (3).

7. Suspensory and head and neck support device, according to claim 1, whereby the main circular band (1) has an adjustment and breakage clip (9) which can break in the event of extreme tension, for the safety of the user and in the case of an emergency.
